(19) United States
(12) Patent Application Publication
(10) Pub. No.: US 2023/0080186 A1
(43) Pub. Date: Mar. 16, 2023

(54) REMOTE CONTROL MODEL CAR AND CONSOLE

(71) Applicant: JIAN HU, Shenzhen (CN)

(72) Inventor: JIAN HU, Shenzhen (CN)

(21) Appl. No.: 17/475,375

(22) Filed: Sep. 15, 2021

(51) Int. Cl. A63H 30/04; A63H 17/36; A63H 17/42

(52) U.S. Cl. CPC A63H 30/04; A63H 17/36; A63H 17/42; A63H 30/06

(57) ABSTRACT

A remote control model car and console is disclosed. The remote control model car and console includes a model car includes an ECU and a console that is wirelessly connected to the model car through the ECU. The console includes a movable chassis, a steering wheel, a pedal, a seat, a monitor, a support rod, and a support frame. The support rod is fixed to the movable chassis on one side. The monitor is fixed to an upper end of the support rod. The support frame is fixed to an upper end of the movable chassis. The seat is fixed at an inner side of the support frame, and the pedal is fixed to the support frame on the side of the seat adjacent to the monitor.

### TECHNICAL FIELD

The present disclosure relates to the technical field of automobile and racing car driving simulators, and in particular relates to a remote control model car and console.

### BACKGROUND

In the field of racing, real-person driving is usually adopted, which is however expensive and dangerous; while in the field of remote control model cars, controlling racing car models by handheld remote controls lacks feedback from real cars, hence a low sense of involvement for the controllers.

### SUMMARY

The purpose of the present disclosure is to provide a remote control model car and console to provide a type of remote control racing car that is remotely controlled through the console, while real driving data such as the car’s field of view, steering force, braking pressure, and chassis dynamics are fed back to the console for execution in real time, allowing the controller to obtain an immersive driving experience.

To achieve the above purpose, the present disclosure provides the following technical solutions: a remote control model car and a console. The remote control model car and console comprise a model car comprising an ECU and a console that are connected by wireless communication through said ECU. The said console includes a movable chassis, a steering wheel, pedals, a seat, a monitor. A support rod is fixed to the movable chassis on one side. The said monitor is fixed on the upper end of the support rod, a support frame is fixed on the upper end of the movable chassis, the seat is fixed at the inner side of the support frame, and the pedal is fixed to the support frame on the side of the seat near the monitor.

Preferably, said movable chassis has electric push rod fixed at the upper end, where four electric push rod are placed along the four corners of the movable chassis. The said support frame is fixed among the four electric cylinders, and said seat is fixed on the inner side among the support frames. An electric push rod is placed in the horizontal direction, and a controller is fixed at the bottom of the seat.

Preferably, a speaker is fixed to said support rod near the monitor end, and the speaker is electrically connected to the controller. The speaker is located on the side of the monitor.

Preferably, a steering wheel motor is fixed to the upper end of said support frame, and a steering wheel is fixed to the drive shaft of the steering wheel motor.

Preferably, said ECU is connected to a wireless module, a camera, a battery pack, a microphone, a hydraulic pump, a three-axis acceleration sensor, a steering motor, and a drive motor assembly through electric signal. The said drive motor assembly is connected to a drive wheel, where a brake disc is connected to. The brake disc is connected to a brake caliper that is connected to a hydraulic pump. An oil pressure sensor is connected between the hydraulic pump and the brake caliper, and steering front wheels is connected to the other end of the steering motor.

Preferably, the communication distance of said wireless communication is at visual range or remote Internet range.

The beneficial effect of the present disclosure is that the present disclosure realizes a remote control racing car and a console, which not only can remotely control the model car, but also can transmit the real feedback of the car to the driver, who can obtain a real driving control experience in terms of visual, auditory and tactile senses without facing safety problems; at the same time, scaling down the model car can also reduce the cost of making the racing car.

### BRIEF DESCRIPTION OF DRAWINGS

FIG. 1 is a schematic diagram of the connection structure of a remote control model car and console provided by the present disclosure.

FIG. 2 is a schematic diagram of the structure of a model car of a remote control model car and console provided by the present disclosure.

FIG. 3 is a schematic diagram of the structure of a console of a remote control model car and console provided by the present disclosure.

### DETAILED DESCRIPTION OF ILLUSTRATIVE EMBODIMENTS

In the figures: 1. movable chassis; 2. steering wheel; 3. pedals; 4. seat; 5. monitor; 6. support rod; 7. support frame; 8. controller; 9. speaker; 10. steering wheel motor; 11. electric push rod.

In order to further understand the content, features and efficacy of the present disclosure, the following embodiment is described in detail in conjunction with the figures as follows.

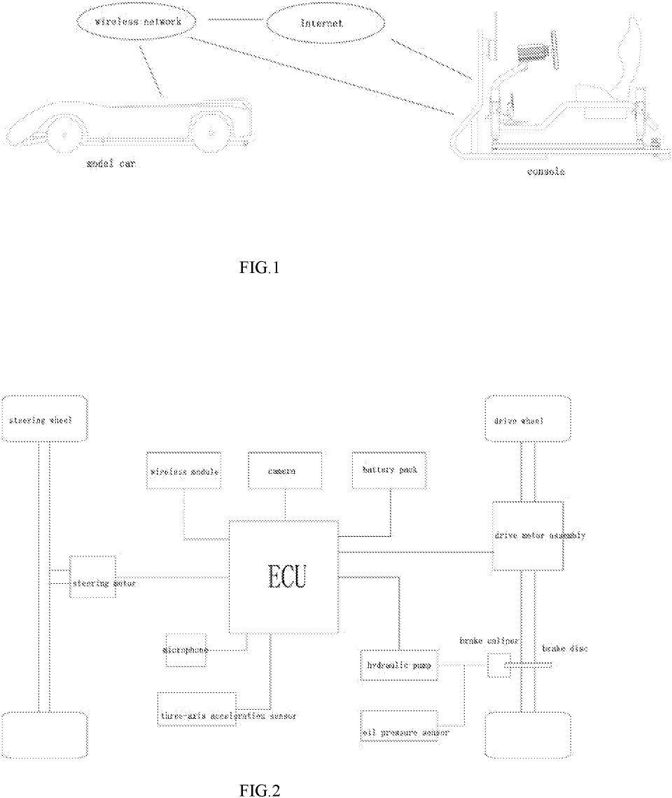

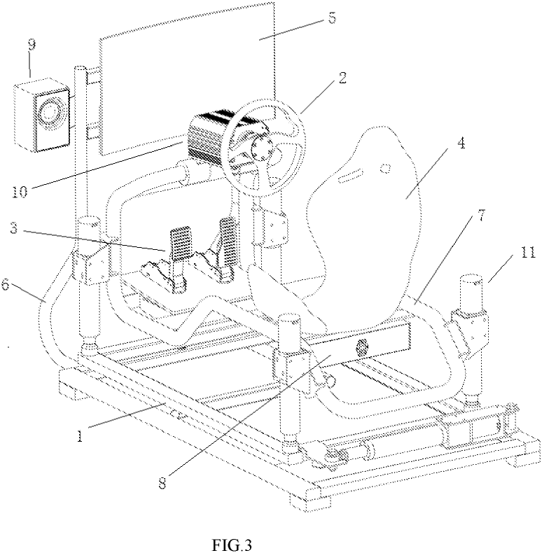

Referring to FIGS. 1-3, the remote control model car and console of an embodiment of the present disclosure will be described in detail below in conjunction with the figures.

The remote control model car and console comprise a model car comprising an ECU and a console that are connected by wireless communication through said ECU. The said console includes a movable chassis 1, a steering wheel 2, pedals 3, a seat 4, a monitor 5. A support rod 6 is fixed to the movable chassis on one side. The said monitor 5 is fixed on the upper end of the support rod 6, a support frame 7 is fixed on the upper end of the movable chassis 1, the seat 4 is fixed at the inner side of the support frame 7, and the pedal 3 is fixed to the support frame 7 on the side of the seat 4 near the monitor 5.

Specifically, the movable chassis (1) has electric push rod (11) fixed at the upper end, where four electric push rod (11) are placed along the four corners of the movable chassis (1). The said support frame (7) is fixed among the four electric cylinders (11), and said seat (4) is fixed on the inner side among the support frames (7). An electric push rod (11) is placed in the horizontal direction, and a controller (8) is fixed at the bottom of the seat (4).

One of the electric push rod 11 is placed in the horizontal direction to achieve horizontal oscillation of the support frame 7.

The controller 8 can receive signals from the ECU for controlling devices including the seat 4, the steering wheel 2, and the pedals 3, and may also convert the operation of these devices into electrical signals to be delivered to the ECU, while the controller may access a wireless or wired network. In addition, the controller 8 can drive the movable chassis 1 in real time to achieve vibration of it; drive the steering wheel motor 10 in real time to achieve steering force feedback; and drive the pedals 3 to achieve braking force feedback.

Specifically, a speaker 9 is fixed to the support rod 6 near the monitor end 5, and the speaker 9 is electrically connected to the controller 8. The speaker 9 is located on the side of the monitor 5.

The monitor 5 displays the video and running signals sent by the model car in real time to the driver to view; audio 9 plays the on-site acoustic information sent by the model car

Specifically, a steering wheel motor 10 is fixed to the upper end of the support frame 7, and a steering wheel 2 is fixed to the drive shaft of the steering wheel motor 10.

Specifically, the ECU is connected to a wireless module, a camera, a battery pack, a microphone, a hydraulic pump, a three-axis acceleration sensor, a steering motor, and a drive motor assembly through electric signal. The said drive motor assembly is connected to a drive wheel, where a brake disc is connected to. The brake disc is connected to a brake caliper that is connected to a hydraulic pump. An oil pressure sensor is connected between the hydraulic pump and the brake caliper, and steering front wheels is connected to the other end of the steering motor.

Specifically, the communication distance of the wireless communication is at visual range or remote Internet range.

In said embodiment: the model car, in addition to be equipped with the mechanical structures required for normal driving, such as power, chassis, suspension, steering and braking, also composes of the following functional modules: steer-by-wire, the steering motor drives the steering rod, and the ECU controls the steering action; steering feedback, to obtain steering force and angle information through the steering motor; brake-by-wire, the hydraulic pump drives the brake oil-way, and the ECU controls the amount of braking force; braking feedback, to arrange oil pressure sensor to obtain brake oil way pressure information; accelerator-by-wire, the ECU drives the electronic throttle to control the power output; car body gesture acquisition, to arrange three-axis acceleration sensor to obtain car body dynamic information; visual acquisition, to arrange multiple cameras to obtain video information of driver’s field of vision in all directions; sound acquisition, to arrange microphone to collect on-site acoustic information; ECU (electronic control unit), to read the sensor information from the whole car to drive the actuator action; the wireless module, to send the data acquired by the ECU to the remote console wirelessly and receives the operation instruction from the console.

The working principle of the present disclosure: in addition to the driving function, the model car can send information to the remote console such as all-direction field of view, speaker, steering force, steering angle, braking pressure, car body dynamics, etc. and the console receives signals from ECU through the controller; the console is equipped with simulated driving function unit, including steering wheel, pedals, seat, etc., and its appearance is consistent with actual cars. The console can execute the feedback information sent by the model car, and provide physical sensation in the form of monitor, speaker, steering wheel motor, pedal vibration motor, movable chassis, etc. The model car and console can be arranged in the field within the range of visibility or in an off-site location through the Internet; the model car can be a 1:1 real car or a scaled-down car; the model car can be either electrically driven or fuel-powered; the model car can be rear-wheel drive, front-wheel or four-wheel drive; the braking method of the model car can be hydraulic, pull-wire or motor back-dragging; the monitor can be LCD, or head-mounted VR monitor or projection monitor; in practical application, various tracks can be laid out to let the model car run in the track.

The console can be located at the track site and interconnected to the model cars via a wireless network ,such as WiFi,5G, etc; or it can be off-site and control remotely via the Internet; the track can run multiple model cars with multiple controller competing from remote locations.

Although embodiments of the present disclosure have been shown and described, it will be understood that ordinary technicians in the field that a variety of variations, modifications, replacements and variants of these embodiments can be made without departing from the principles and spirit of the present disclosure, and the scope of the present disclosure is limited by the appended right claims and their equivalents.

What is claimed is:

1. A remote control model car and console, comprising:
a model car, comprising an ECU (electronic control unit); and
a console in a wireless communication with the model car through the ECU, the console comprising:
a movable chassis;
a steering wheel;
a pedal;
a seat;
a monitor;
a support rod, fixed to the movable chassis on one side, wherein the monitor is fixed on an upper end of the support rod; and
a support frame, fixed on an upper end of the movable chassis, wherein the seat is fixed at an inner side of the support frame, and the pedal is fixed to the support frame on the side of the seat adjacent to the monitor.

2. The remote control model car and console as recited in claim 1 wherein the movable chassis comprises four electric cylinders that are arranged at the upper end of the movable chassis and respectively at four corners of the movable chassis, wherein the support frame is fixed amidst the four electric cylinders, and the seat is fixed on the inner side of the support frame, wherein the four electric cylinders are arranged on a horizontal plane, and a controller is fixed at a bottom of the seat.

3. The remote control model car and console as recited in claim 1 further comprising a speaker fixed to an end of the support rod adjacent to the monitor, wherein the speaker is electrically connected to the controller and disposed on a side of the monitor.

4. The remote control model car and console as recited in claim 2 further comprising a steering wheel motor fixed to an upper end of the support frame, and wherein the steering wheel is fixed to a drive shaft of the steering wheel motor.

5. The remote control model car and console as recited in claim 1 wherein the ECU is connected to a wireless module, a camera, a battery pack, a microphone, a hydraulic pump, a three-axis acceleration sensor, a steering motor, and a drive motor assembly through electric signal, wherein the drive motor assembly is connected to a drive wheel, which is connected to a brake disc, wherein the brake disc is connected to a brake caliper, which is connected to a hydraulic pump, wherein an oil pressure sensor is connected between the hydraulic pump and the brake caliper, and wherein a steering front wheel is connected to the other end of the steering motor.

6. The remote control model car and console as recited in claim 1 wherein a communication distance of the wireless communication is at a visual range or a remote Internet range.
